(19) United States
(12) Patent Application Publication
(10) Pub. No.: US 2009/0058847 A1
(43) Pub. Date: Mar. 5, 2009

(54) METHODS AND SYSTEMS INVOLVING FACETED BROWSING WITH TAGS

(75) Inventor: Scott M. Lewis, Toronto (CA)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/847,031

(22) Filed: Aug. 29, 2007

(51) Int. Cl. G06F 17/00

(52) U.S. Cl. 345/418

(57) ABSTRACT

A method for organizing and displaying data includes classifying data objects with facets, wherein facets are aspects that include subjects of the data objects, associating tags with the data objects, wherein the tags are descriptive labels of the data objects, associating the tags with the facets, displaying the facets in response to a request for data objects, displaying the tags associated with the displayed facets in further response to the request for data objects, and displaying data objects corresponding to the displayed facets in further response to the request for data objects.

### BACKGROUND OF THE INVENTION

1. Field of the Invention

This invention relates to querying information classified with metadata, and particularly to metadata involving tags and facets.

2. Description of Background

The growth of information resources including the Internet has resulted in an enormous amount of information that may be accessed by users. The scope of this information is broad and drives a demand for methods for effectively classifying the information for easier information retrieval.

A piece of data or information may be called a data object. Tags are words associated with a particular data object and may be used to enable retrieval of data objects by a user. Facets are descriptive words used in a hierarchal system for classifying data objects. Both tags and facets offer advantages for data retrieval, however each have limitations based on the data retrieval needs of a user.

Thus, it is desirable for a data retrieval system to enable a user to more effectively access data objects.

### SUMMARY OF THE INVENTION

The shortcomings of the prior art are overcome and additional advantages are provided through the provision of a method for organizing and displaying data, the method comprising, classifying data objects with facets, wherein facets are aspects that include subjects of the data objects, associating tags with the data objects, wherein the tags are descriptive labels of the data objects, associating the tags with the facets, displaying the facets in response to a request for data objects, displaying the tags associated with the displayed facets in further response to the request for data objects, and displaying data objects corresponding to the displayed facets in further response to the request for data objects.

An exemplary system for organizing and displaying data, the system comprising, data objects stored in a memory, wherein the data objects are classified with facets and tags are associated with the data objects, and the tags are further associated with the facets, and a processor, wherein the processor is operative to receive a request for data objects and responsive to the request for data objects output the data objects, the facets, and the tags corresponding to the request for data objects to a display.

Another embodiment includes a computer readable medium with logic, wherein the logic is operative to classify data objects with facets, wherein facets are aspects that include subjects of the data objects, associate tags with the data objects, wherein the tags are descriptive labels of the data objects, associate the tags with the facets, display the facets in response to a request for data objects, display the tags associated with the displayed facets in further response to the request for data objects, and display data objects corresponding to the displayed facets in further response to the request for data objects.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a block diagram of an exemplary data retrieval system.

FIG. 2 illustrates a block diagram of an exemplary method for classifying and retrieving data.

FIG. 3 illustrates an exemplary embodiment of a browsing interface on a display of a data retrieval system.

FIG. 4 illustrates the exemplary embodiment of a browsing interface on a display of a data retrieval system of FIG. 3.

FIGS. 5a and 5b illustrate a prior art example of a browsing interface on a display of a facet data retrieval system.

FIGS. 6a and 6b illustrate a prior art example of a browsing interface on a display of a tag cloud data retrieval system.

The detailed description explains the preferred embodiments of the invention, together with advantages and features, by way of example with reference to the drawings.

### DETAILED DESCRIPTION OF THE INVENTION

Systems and methods involving classifying and browsing of faceted information via clouds are provided.

In this regard, information stored in memory in a database or another system that includes stored information such as the Internet should be organized to facilitate efficient retrieval of data by a user. Information on the Internet or a database may comprise data objects. A data object is a particular piece of information. Thus, when a user desires a particular piece of information, they may use a browser interface to search for a data object.

One method for classifying data objects uses facets. A facet is an aspect that includes subjects of a data object. A facet is an isolated perspective on a data object. A user may classify each data object by subjects (facets). For example, if a database includes a plurality of recipes, each recipe would be a data object. Facets may include, for example, “courses”, “meals”, and “ingredients” related to each data object. Each facet may be further subdivided into other facets. The “courses” facet may include the facets “appetizers,” “entrées,” and “deserts”, the ingredients facet may include “chicken,” “pork,” “rice,” “beef,” “ice cream,” and “pastas.”

Thus, if a recipe for spaghetti with meatballs includes spaghetti pasta, tomato sauce, meatballs, and oregano, the spaghetti with meatballs data object may be classified with the facets, entrée, beef, dinner, and pasta.

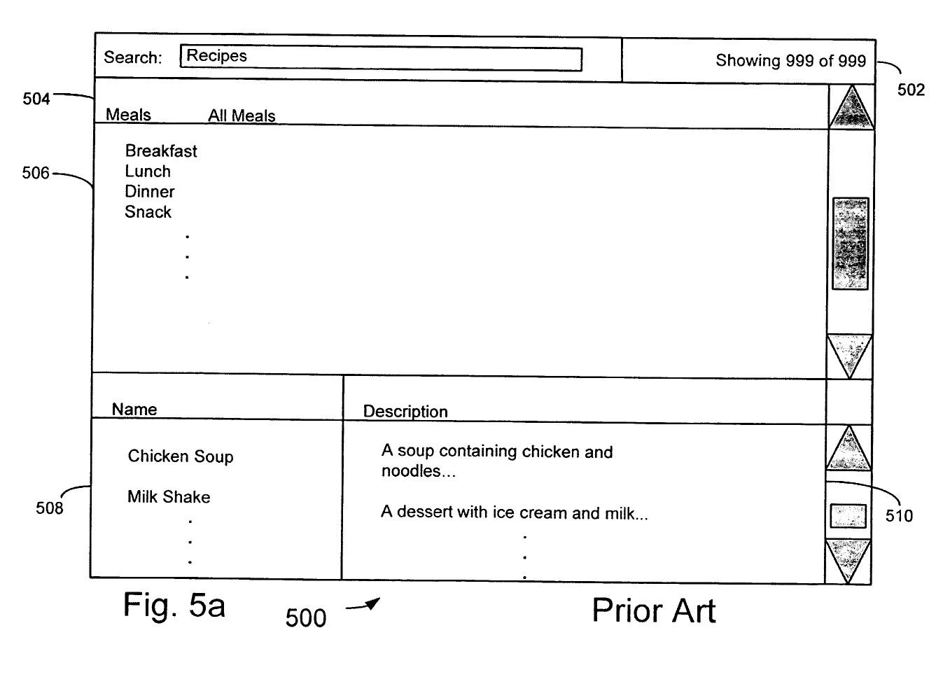

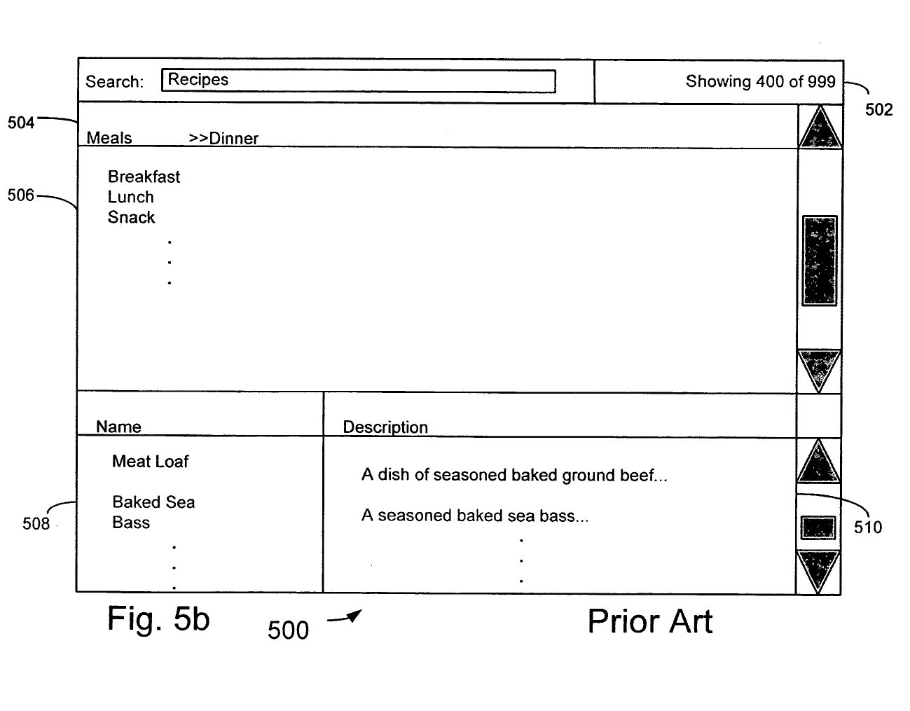

An example of a prior art browser interface 500 for searching for data objects using facets is illustrated in FIGS. 5a and 5b. In operation, if a user is using the browser interface to find the recipe for spaghetti with meatballs the user may enter a search term recipes. The facet “Meals” is displayed in a facet bar 504. The facet “Meals” is subdivided into other facets (e.g., “Breakfast”, “Lunch”, “Dinner”, and “Snack” . . . ) that are displayed in a facet box 506. All of the data objects classified under the facet “Meals” are displayed in a data object name box 508 that display the name of each data object (e.g., “Chicken Soup,” “Milk Shake,” . . . ), and a data object description box 510 that displays a description of each data object (e.g. A soup containing chicken and noodles . . . ). A status bar 502 indicates that 999 data objects of 999 total data objects are displayed.

Referring now to FIG. 5b, since the desired recipe, spaghetti with meatballs, is a dinner, the user may select the “Dinner” facet from the facet box 506. The facet bar 504 responsively displays the facet “Dinner.” The data object name box 508 now displays the name of each data object (e.g., “Meat Loaf,” “Baked Sea Bass”, . . . ) that is classified with the “Dinner” facet. The data object description box displays a description of each data object. The status bar 502 has been updated to indicate that 400 data objects of 999 total data objects are displayed. A user may then scroll through the data object name box 508 to find the desired recipe for “Spaghetti with Meatballs.”

Tags are used in another method for indexing and retrieving data objects. A tag is a word that is associated with a data object. A group of tags may be grouped into a cloud. The recipe for “Spaghetti with Meatballs” data object may, for example, be associated with the tags spaghetti pasta, beef, meatballs, Italian, spices, and each of the tags may be included in a cloud.

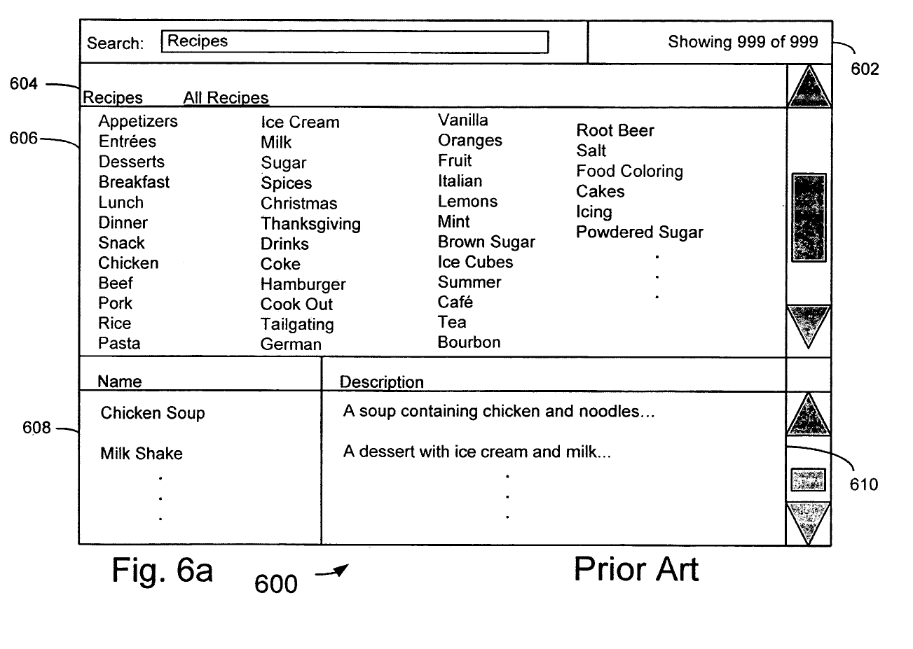

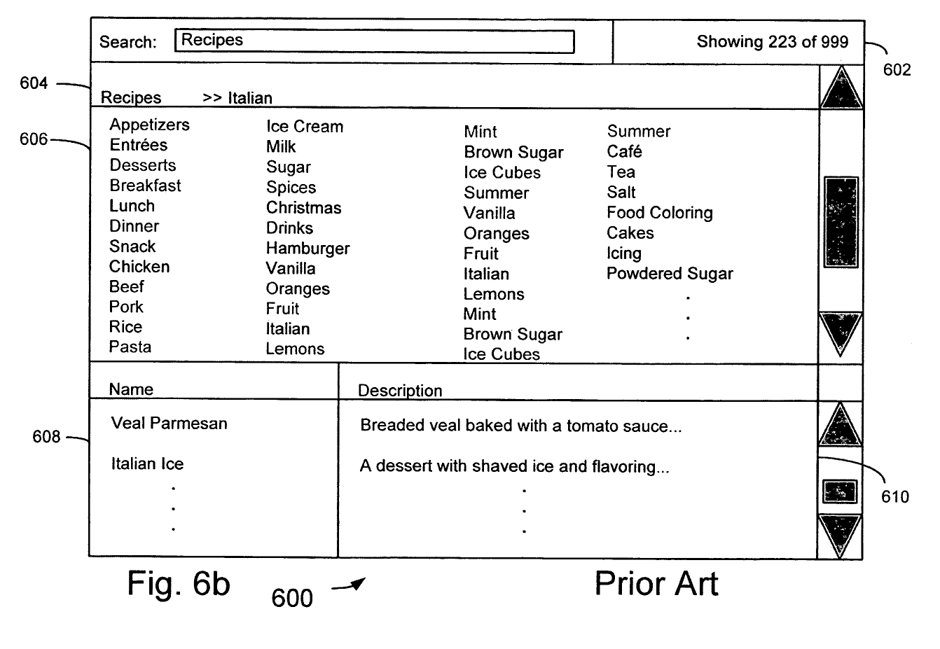

FIGS. 6a and 6b illustrate an example of a prior art browser interface 600 for using tags and clouds to find data objects. Referring to FIG. 6a, if a user would like to find a recipe for “Spaghetti with Meatballs,” the user may enter a search term such as “Recipes.” The browser interface 600 then displays the tag “Recipes” in a tag bar 604. All of the tags associated with the search term “Recipes” are displayed in a cloud box 606. A status bar 602 indicates that a data object name box 608 and a data object description box 610 are displaying 999 of 999 available data objects associated with the tag “Recipes.”

Referring now to FIG. 6b, since the user desires a recipe for “Spaghetti with Meatballs”, the user selects the tag “Italian” from the cloud box 606. The tag bar 604 now displays the tags “Recipes” and “Italian.” The status bar 602 indicates that the data object name box 608 and the data object description box 610 are displaying 223 of 999 available data objects that are associated with the tags “Recipes” and “Italian.” A user may then scroll through the data object name box 608 to find the desired recipe for “Spaghetti with Meatballs.”

Each of the above described examples of a prior art systems using facets and tags for data retrieval may require several steps and considerable time for a user to find the desired data objects. The embodiments of a data system browser that allows browsing using facets and tags, thereby enabling a user to access desired data objects more quickly and efficiently are described.

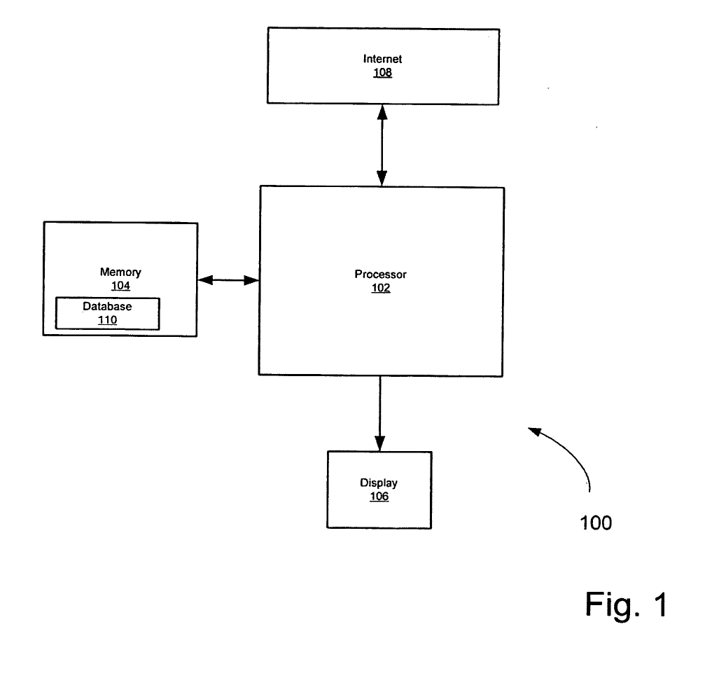

Referring to FIG. 1, FIG. 1 illustrates a block diagram of a system 100 that includes a processor 102, a memory 104 communicatively connected to the processor 102, and a display 106 communicatively connected to the processor 102. The memory may include a database 110. The processor 102 is also communicatively connected to the Internet 108.

A user may use the processor 102 to store and classify data objects in the memory 104, the database 110, and the Internet 108. The user may also use the processor to browse for data objects stored in the memory 104, the database 110 and the Internet 108. The processor 102 may display a browser interface on the display 106.

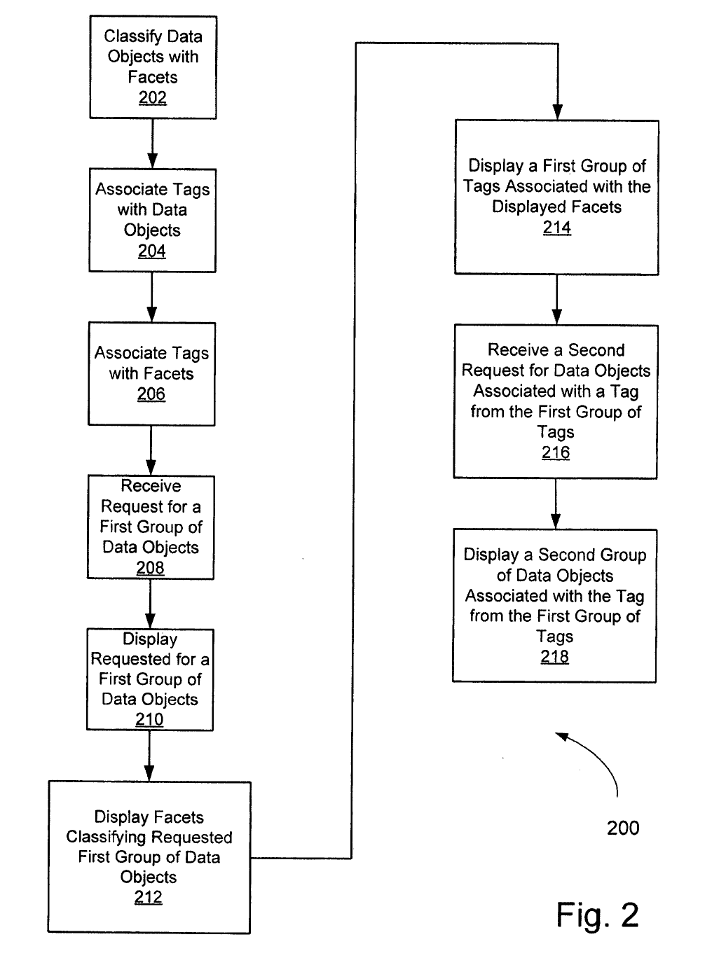

FIG. 2 illustrates a block diagram of a method 200 for classifying and displaying data objects stored in the system 100 of FIG. 1. Method 200 allows a user to classify data objects using both facets and tags and retrieve data objects using tags and facets.

In this regard, method 200 begins at block 202, classifying data objects with facets. Once the data objects are classified by a user with facets, the user associates tags with the data objects in block 204. The tags are then associated by the user with the facets in block 206. Once the data objects are classified with facets and associated with tags, and the tags are associated with the facets, a user may request a first group of data objects using, for example, a browser interface on a display. The system 100 receives the user request for a group of data objects in block 208. The requested first group of data objects is displayed in block 210. The facets classifying the requested first group of data objects are displayed in block 212 and a first group of tags associated with the displayed facets are displayed in block 214. The system 100 receives a second request for data objects associated with a tag from the first group of tags in block 216. The system 100 then displays a second group of data objects associated with the tag from the first group of tags in block 218.

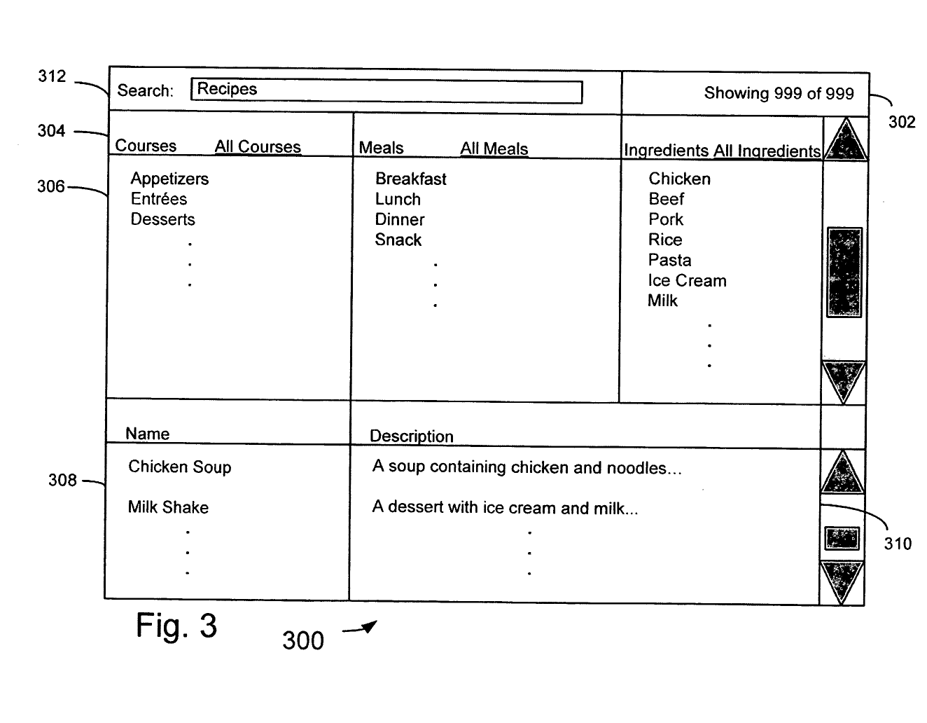

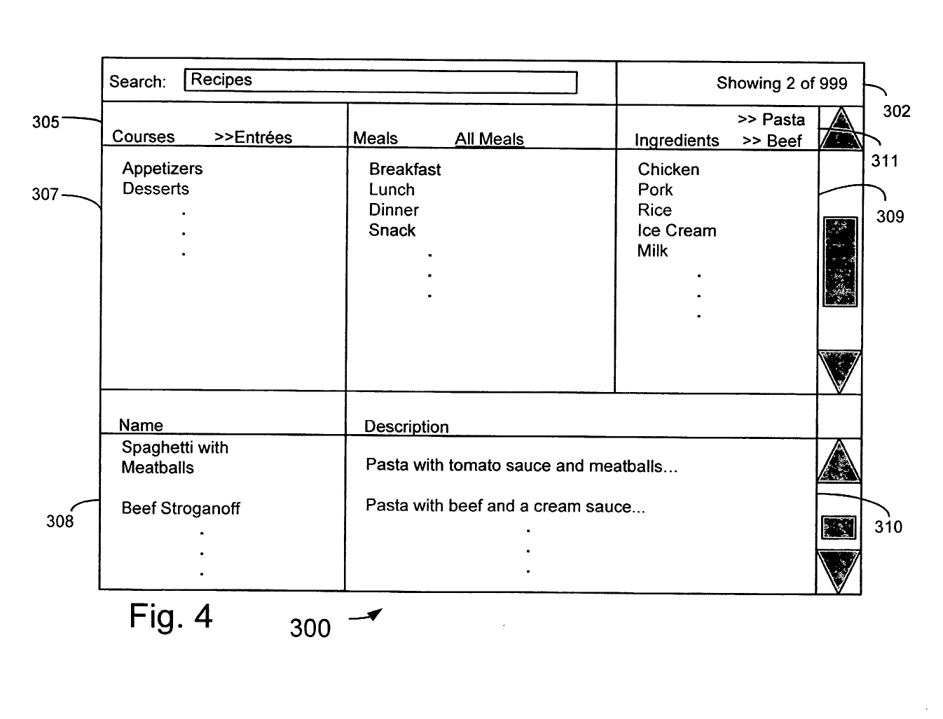

The method 200 may be further understood by referring to FIGS. 3 and 4. FIGS. 3 and 4 include an exemplary embodiment of a browser interface for retrieving data objects in the system 100. In the exemplary embodiment of FIGS. 3 and 4, a user is using the browser interface to retrieve data objects that include recipes.

In this regard, FIG. 3 includes a browser interface 300. The browser interface 300 includes a status bar 302, facet bars 304, cloud boxes 306, a data object name box 308, a data object description box 310, and a search box 312.

In operation, a user enters a search term in the search box 312. In the illustrated example of FIG. 3, the user has entered the search term “Recipes.” The processor 100 (shown in FIG. 1) receives the search term and searches the database 110 in the memory 104 (shown in FIG. 1) for recipes. In the illustrated embodiment, the processor has searched the database 110 for data objects, while the processor may also search other sources of data stored in memory such as the Internet 108.

The status bar 302 displays the number of data objects found in the search, and the number of data objects displayed. In this illustrated example of FIG. 3, the processor 100 has found 999 recipes and is displaying 999 recipes in the data object name box 308 and a data object description box 310. The data object name box 308 displays the name of each data object (e.g. “Chicken Soup,” “Milk Shake,” . . . ), while the data object description box 310 displays a description of each data object (e.g. “A soup containing chicken and noodles . . . ”).

In the illustrated embodiment of FIG. 3, the data objects have been classified with facets and associated with tags. The tags have also been associated with the facets as described in the method 200. Thus, the browser interface 300 displays facets classifying the data objects (e.g. “Courses,” “Meals,” “Ingredients”) in the facet bars 304 and clouds of tags associated with the data objects (e.g. “Appetizers,” “Entrées,” “Breakfast,” “Chicken,” “Beef” . . . ) and the facets in the cloud boxes 306.

In the illustrated example of FIGS. 3 and 4, the user is interested in recipes for entrées that include pasta and beef. Referring now to FIG. 4, the user has selected the tag “Entrées” from the cloud box 307 under the facet bar 305. The tag “Entrées” is displayed in the facet bar 305. The user has also selected the tags “Pasta” and “Beef” from the cloud box 309. The tags “Pasta and “Beef” appear in the facet bar 311.

The database 110 includes two data objects that have the associated tags “Entrées,” “Pasta,” and “Beef.” Thus, the a data object name box 308 and a data object description box 310 display the data objects named Spaghetti with Meatballs and Beef Stroganoff. The status bar 302 has been updated to indicate that 2 data objects of 999 data objects are displayed.

The illustrated exemplary embodiment of FIGS. 3 and 4 show an exemplary browser interface that allows a user to use both facets and tags to search for and display data objects from a large database. The use of both facets and tags allows a user to more effectively and efficiently find information in a database or on the Internet.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for organizing and displaying data, the method comprising:
classifying data objects with facets, wherein facets are aspects that include subjects of the data objects;
associating tags with the data objects, wherein the tags are descriptive labels of the data objects;
associating the tags with the facets;
displaying the facets in response to a request for data objects;
displaying the tags associated with the displayed facets in further response to the request for data objects; and
displaying data objects corresponding to the displayed facets in further response to the request for data objects.

2. The method for organizing and displaying data of claim 1, wherein the method further comprises displaying the number of data objects displayed in the response to the request for data objects.

3. The method for organizing and displaying data of claim 1, wherein the method further comprises displaying the number of data objects available in a database in the response to the request for data objects.

4. A system for organizing and displaying data, the system comprising:
data objects stored in a memory, wherein the data objects are classified with facets and tags are associated with the data objects, and the tags are further associated with the facets; and
a processor, wherein the processor is operative to receive a request for data objects and responsive to the request for data objects displaying the facets in response to a request for data objects, displaying the tags associated with the displayed facets in further response to the request for data objects, and displaying data objects corresponding to the displayed facets in further response to the request for data objects.

5. A computer readable storage medium, comprising:
a computer readable computer program code for organizing and displaying data; and
instructions for causing a computer to implement a method, the method further comprising:
displaying facets in response to a request for data objects, wherein facets are aspects that include subjects of the data objects;
displaying tags associated with the displayed facets in further response to the request for data objects, wherein the tags are descriptive labels of the data objects; and
displaying data objects corresponding to the displayed facets in further response to the request for data objects.

6. The computer readable storage medium of claim 5, wherein the method further comprises displaying the number of data objects displayed in the response to the request for data objects.

7. The computer readable storage medium of claim 5, wherein the method further comprises displaying the number of data objects available in a database in the response to the request for data objects.
